(19) United States
(12) Patent Application Publication
(10) Pub. No.: US 2026/0103372 A1
(43) Pub. Date: Apr. 16, 2026

(54) CAPPING MACHINE WITH AUTOMATIC TORQUE CONTROL

(71) Applicant: NJM Packaging Inc., Saint-Laurent (CA)

(72) Inventors: David VINCENT, Mirabel (CA); Alexandru BERCEANU, Saint-Eustache (CA); Maxime DEMERS, Laval (CA); Khalid BOUROUDANE, Lachine (CA)

(21) Appl. No.: 19/350,452

(22) Filed: Oct. 6, 2025

Related U.S. Application Data
(60) Provisional application No. 63/708,112, filed on Oct. 16, 2024.

(51) Int. Cl. B67B 3/20; B65B 7/28

(52) U.S. Cl. CPC B67B 3/2093; B65B 7/2835; B67B 3/2046

(57) ABSTRACT

A capping machine includes a container path, and a capping station at which threaded caps are rotated onto threaded finishes of the containers, wherein the capping station includes a pair of laterally opposed cap screwing belts that are operated and configured to screw threaded caps during container movement. A control system is configured to: automatically determine a torque applying characteristic during application of the threaded caps; automatically compare the torque applying characteristic to an established torque criteria; and if a result of the comparison indicates that the torque applying characteristic is not consistent with the established torque criteria, automatically adjust at least one component of the capping machine to bring the torque applying characteristic back into consistency with the established torque criteria. The torque applying characteristic may be a running average of detected finish torques for multiple caps. The established torque criteria may be a set acceptable finish torque range.

### TECHNICAL FIELD

The present application relates generally to container handling and, more particularly, to container capping.

### BACKGROUND

Automatic capping of containers is common in many industries. One type of capping machine used to perform the capping process screws a threaded cap on a threaded container having a threaded finish. To that effect, the capping machine may advance the containers with a conveyor. At some point along the conveyor, a cap is positioned above the container and the cap and container assembly subsequently moves to a capping head. For example, the capping head includes a pair of belts moving at different speeds between which the cap moves. The belts move one side of the cap faster than the other side, due to belt speed differential, which screws the cap as the container advances along the conveyor. U.S. Patent No. 7,325,369, the entirety of which is incorporated herein by reference, discloses one such capping machine. Machines implemented in accordance with this patent have included a manual adjustment knob to vary the position of the belts relative to the path of the cap to enable manual adjustment of belt to cap contact, and also included a manual adjustment knob to adjust final torque of cap tightening (e.g., by varying an air pressure applied to a slip-clutch, thereby varying the torque at which the slip clutch slips). In practice, such capping machines rely on an operator to achieve desired capping specifications. A number of factors can impact proper cap torquing, and capping effectiveness can vary based upon operator skill and attentiveness.

Accordingly, it would be desirable to provide a capping machine with automated torque control.

### SUMMARY

In one aspect, a method is provided for capping containers in a capping machine that includes a container path along which containers move and a capping station at which threaded caps are rotated onto threaded finishes of the containers, wherein the capping station includes a pair of laterally opposed cap screwing belts that are operated and configured to screw threaded caps during container movement until a torque threshold is achieved. The method involves: automatically determining a torque applying characteristic during application of the threaded caps; automatically comparing the torque applying characteristic to an established torque criteria; and if a result of the comparison indicates that the torque applying characteristic is not consistent with the established torque criteria, automatically adjusting at least one component of the capping machine to bring the torque applying characteristic back into consistency with the established torque criteria.

In another aspect, a method is provided for adjusting a capping machine that includes a container path along which a container moves and a capping station having a pair of laterally opposed cap screwing belts that are operated and configured to screw a threaded cap onto the container during container movement, the capping machine also including a controller. The method involves at least one of: the controller detecting whether the threaded cap causes a specified lateral shift in at least one of the cap screwing belts and, if not, automatically decreasing a lateral spacing between the cap screwing belts; and/or the controller detecting whether a specified one of the cap screwing belts moves at least a specified distance during application of the threaded cap onto the container and, if not, automatically lowering a pressure applied to a slip-clutch associated with the specified one of the cap screwing belts.

In another aspect, a capping machine includes a container path along which containers move; and a capping station at which threaded caps are rotated onto threaded finishes of the containers, wherein the capping station includes a pair of laterally opposed cap screwing belts that are operated and configured to screw threaded caps during container movement. A control system is configured to: automatically determine a torque applying characteristic during application of the threaded caps; automatically compare the torque applying characteristic to an established torque criteria; and if a result of the comparison indicates that the torque applying characteristic is not consistent with the established torque criteria, automatically adjust at least one component of the capping machine to bring the torque applying characteristic back into consistency with the established torque criteria.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1A-1B show a capping machine and certain internal portions thereof;

FIGS. 2A-2C and show perspective views of portions of the capping station of the machine;

FIGS. 4 shows a side elevation view of portions of the capping station, looking perpendicular to the conveying direction;

FIG. 5 shows an end elevation view of portions of the capping station, looking in the conveying direction;

FIG. 6 shows a perspective view of portions of the capping station;

FIG. 7 shows another side elevation view of portions of the capping station;

FIG. 8 shows an end elevation view looking along line A-A of FIG. 7;

FIG. 9 shows another end elevation view of portions of the capping station;

FIG. 10 shows a top plan view looking along line C-C of FIG. 9;

FIG. 11 shows a cross-section view looking along line B-B of FIG. 9;

FIG. 12 shows a cross-section view along line D-D of FIG. 9; and

FIG. 13 shows an exemplary flow chart of machine operation.

### DETAILED DESCRIPTION

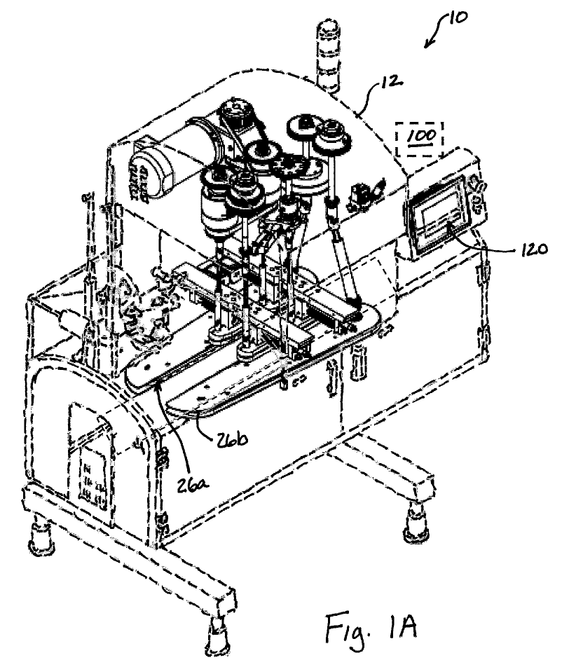

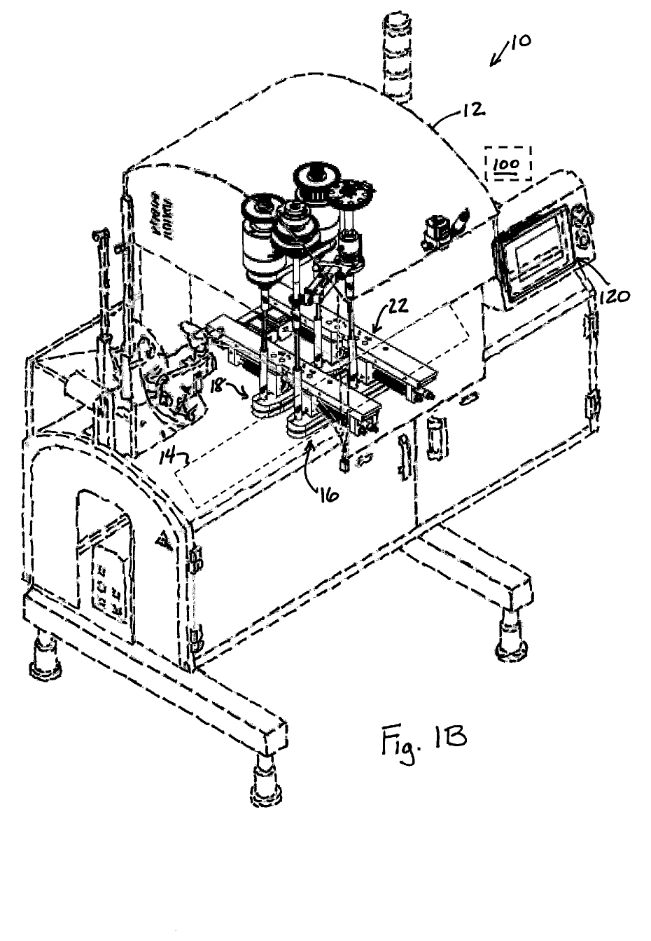

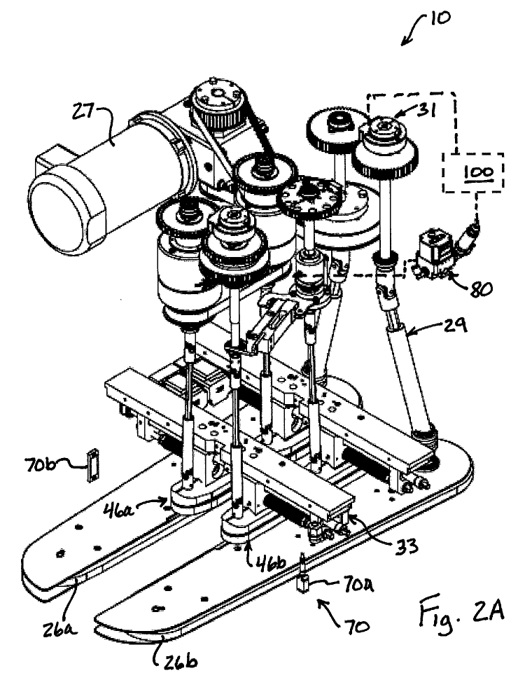

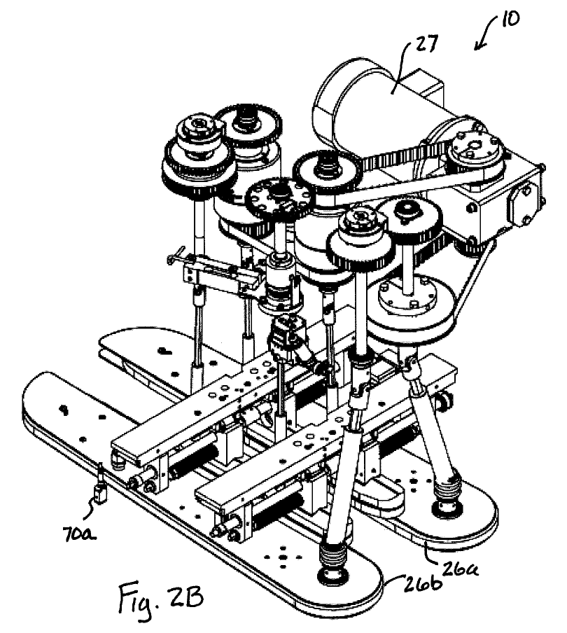

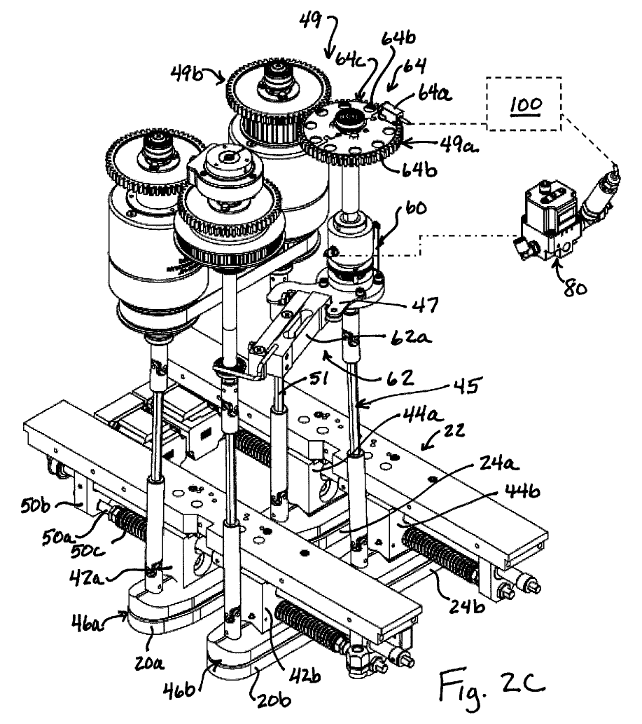

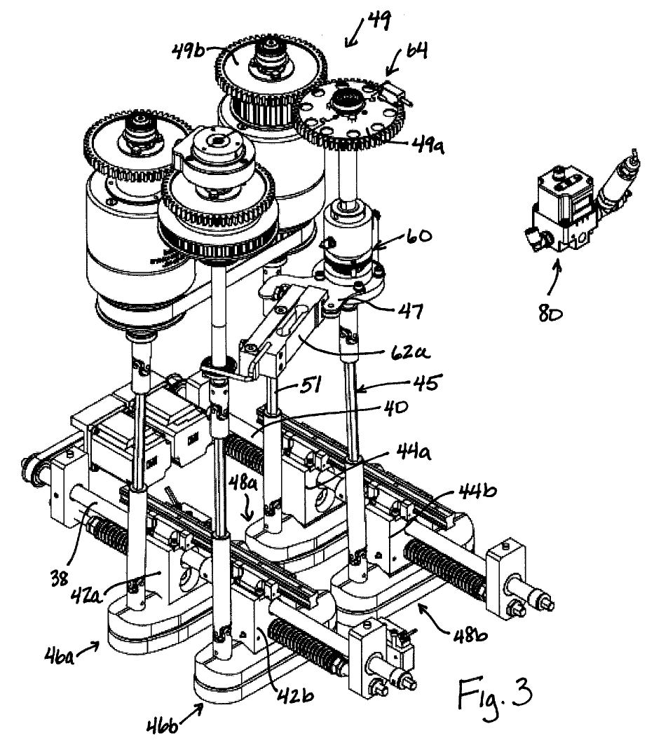

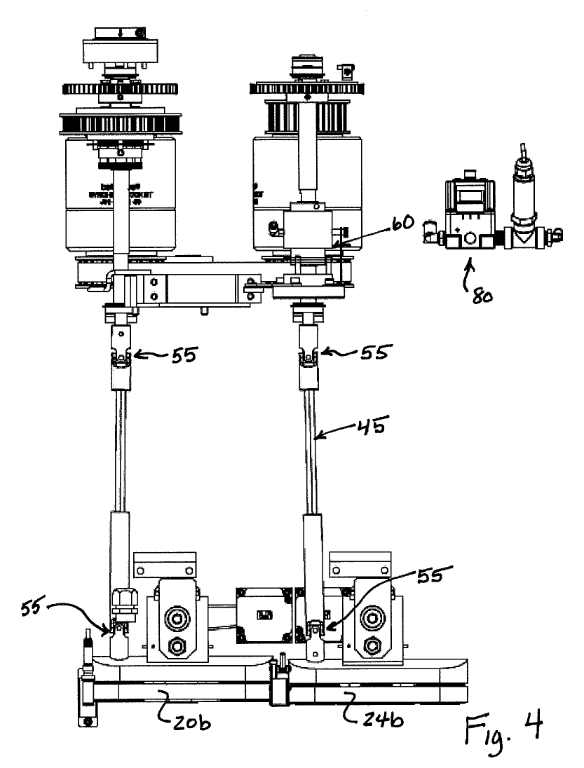

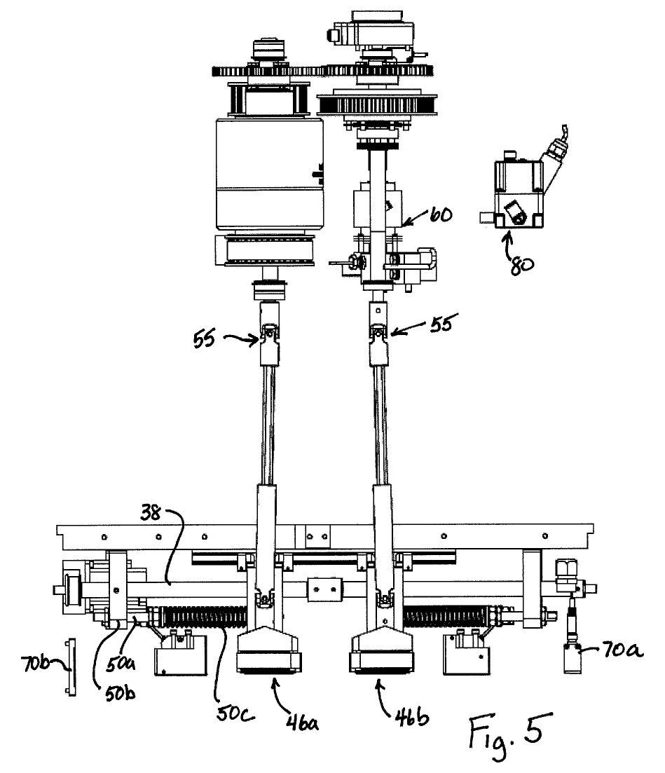

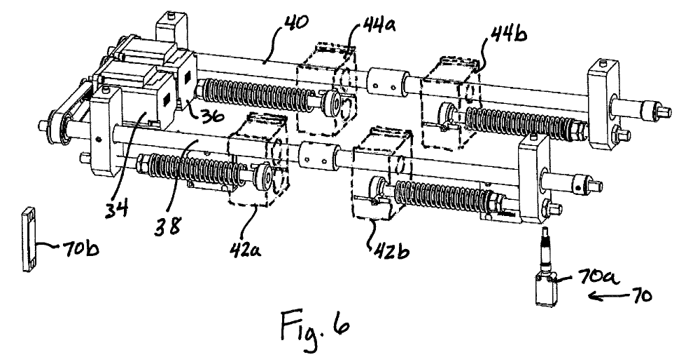

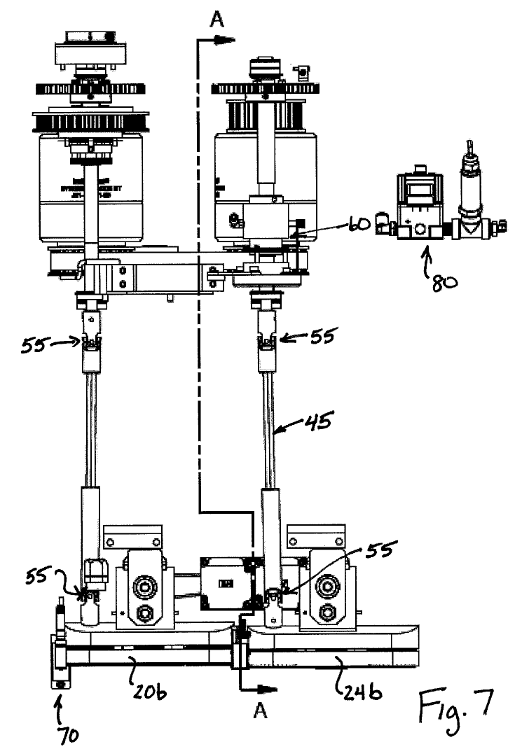

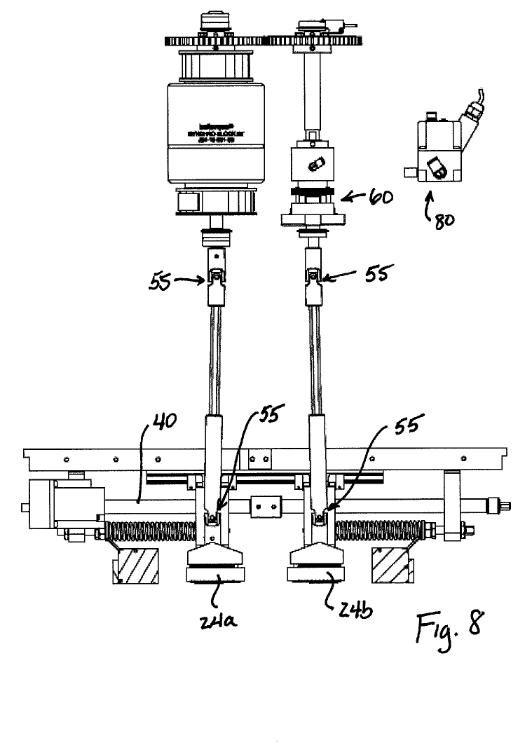

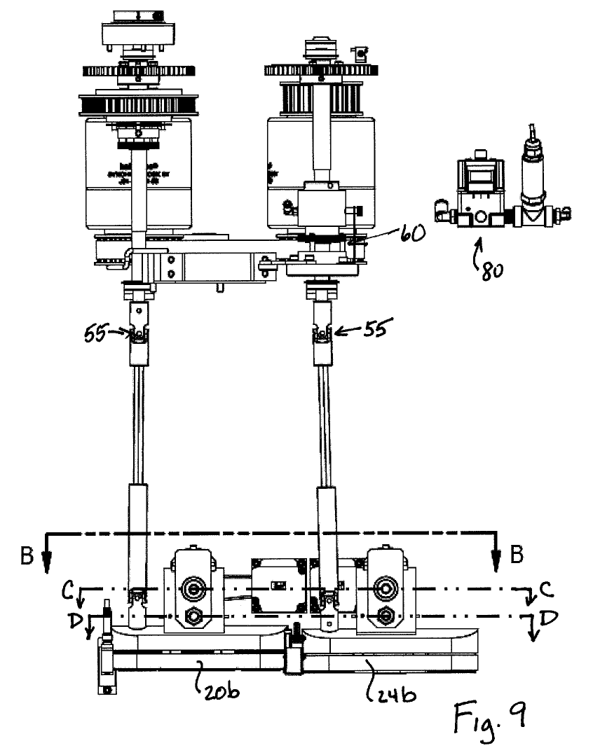

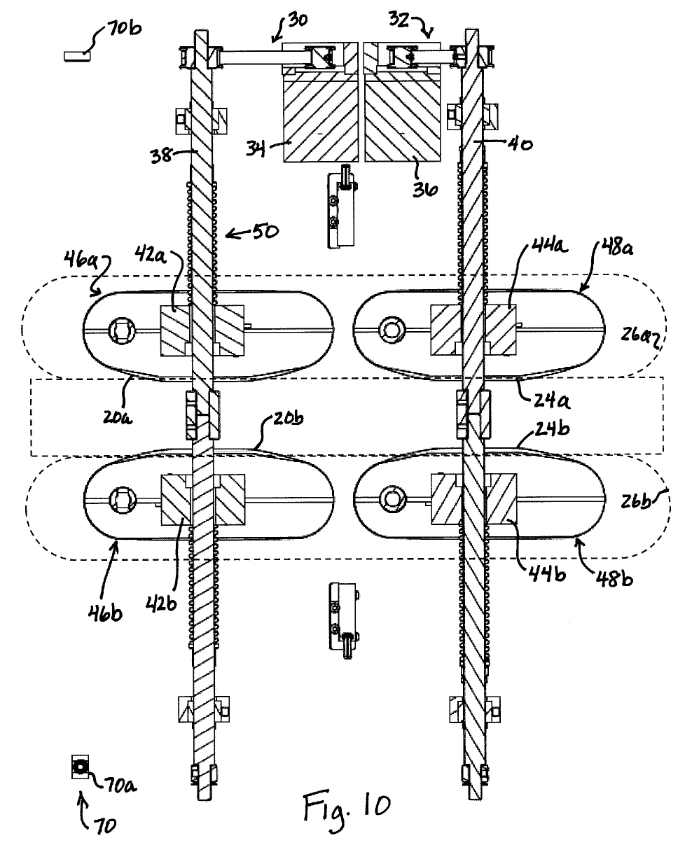

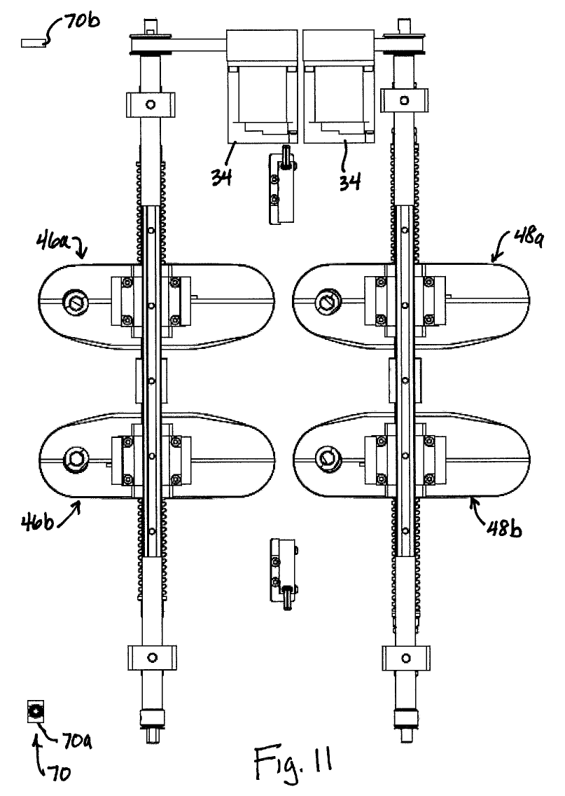

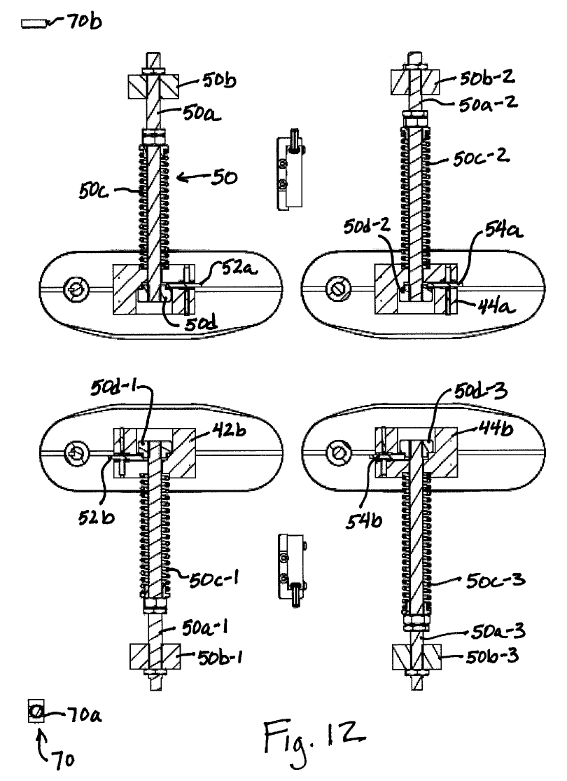

Referring to FIGS. 1-12, a capping machine 10 includes a housing 12 and a main conveyor 14 for carrying containers therethrough. Within the housing, a capping station 16 is provided and, here, includes an upstream cap rotating section 18 with a pair of laterally opposed cap screwing belts 20a, 20b, and a downstream cap rotating section 22 with a pair of laterally opposed cap screwing belts 24a, 24b. Generally, in terms of screwing a cap onto a container, the belts 20a, 20b and belts 24a, 24b may operate substantially as described in U.S. Patent No. 7,325,369, such that respective drives of the respective belt pairs utilize differentials, each having an input and two outputs. When the input is rotated at a predetermined rotational speed, the two outputs are driven such that the sum of the rotational speeds of the two outputs is equal to twice the predetermined speed. The exact rotational speed of the two outputs depends on torques resisting the rotation of the two outputs. As described in U.S. Patent No. 7,325, 369, during application of a cap to a container, movement of the container may be controlled by another set of laterally opposed belts 26a, 26b spaced below the belt pairs 20a, 20b and 24a, 24b.

In terms of feeding of caps to the capping station 16, a system such as that described in U.S. Patent No. 10,351,405, the entirety of which is incorporated herein by reference, may be used, or any other suitable cap feeding system may be used.

Adjustment systems 30, 32 are provided for adjusting a lateral spacing between respective belt pairs 20a, 20b and 24a, 24b. The systems 30, 32 include respective motors 34, 36 that rotate respective mount shafts 38, 40 that are threadedly passed through support blocks 42a, 42b and 44a, 44b, where support block 42a supports a belt frame assembly 46a (e.g., frame and pulleys) for belt 20a, support block 42b supports a belt frame assembly 46b for belt 20b, support block 44a supports a belt frame assembly 48a (e.g., frame and pulleys) for belt 24a, and support block 44b supports a belt frame assembly 48b for belt 24b. Rotating the shafts 38, 40 in one direction moves the belt frame assemblies inward toward a centerline of the conveyance path and rotating the shafts 38, 40 in the opposite direction moves the belt frame assemblies outward away from the centerline of the conveyance path.

By way of example, support block 42a includes a laterally inward biasing system 50 comprised of a fixed shaft 50a that is connected to a bracket 50b, with a spring 50c disposed between the bracket 50b and the support block 42a and urging the support block 42a away from the bracket 50b and laterally toward the conveyance path of the container and caps. A nut 50d limits the movement of the support block 42a away from the bracket 50b, but the support block 42a can slide along the shaft 50a toward the bracket 50b when the bias force of the spring 50c is overcome. A force applied laterally outward against the belt 20a (e.g., by a cap moving between the belts pairs) is transferred to the support block 42a and can cause this movement of the support block 42a. Each of the support blocks 42b, 44a and 44b includes a similar biasing system (e.g., systems 50-1, 50-2, 50-3, with respective shafts (50a-1, 50a-2, 50a-3), brackets (50b-1, 50b-2, 50b-3), springs (50c-1, 50c-2, 50c-3) and nuts (50d-1, 50d-2, 50d-3)).

Here, one or both support blocks 42a, 42b carry a sensor (e.g., 52a, 52b) that is able to detect the movement of the support block laterally outward along the shaft against the spring bias (e.g., movement of the sensor 52a away from the nut 50d is detected). The capping machine includes a controller 100 that is configured to utilize the sensor output to make a determination of whether a cap moving through the belt pair is in sufficient contact with the belts. Support blocks 44a, 44b include similar sensors 54a, 54b.

As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group - including hardware or software that executes code), software, firmware and/or other components, or a combination of some or all of the above, that carries out the control functions of the machine or the control functions of any component thereof. A control system of the capping machine is made up by the controller 100 and various feedback components (e.g., sensors 52a, 52b and the below mentioned strain gauge 62a and displacement detection system 64) and controlled components (e.g., motors 34, 26 and the below mentioned pressure control assembly 80).

U-joints 55 in the drive and drive/driven shafts facilitate the lateral adjustment of the positions of the belts.

The downstream cap rotating section 22 acts as a cap tightening section in which the goal is to achieve a desired final or finish torque of application of the caps onto the containers. A slip clutch 60 is provided for this purpose, with the torque at which the slip clutch slips being variable according to an air pressure applied to the slip clutch (e.g., lowering the clutch pressure results in a lower torque required for slip, and raising the clutch pressure resulting in a higher torque required for slip). In this capping machine, the clutch pressure is controllable by the controller 100 in an automated manner via a pressure control assembly 80, which may be a proportional air regulator that adjusts the output pressure, which is delivered to the slip clutch 60. In this regard, a torque sensing arrangement 62 (e.g., including a strain gauge 62a) detects the final or finish torque (e.g., based upon the output of the strain gauge 62a when slip of the slip clutch occurs). Here, a displacement detection system 64 for detecting movement of belt 24b is also provided, and includes a sensor 64a that detects openings 64b in a gear plate 64c, where the openings 64b are equally spaced around the gear plate 64c.

The displacement detection system 64 is used to identify when the slip clutch is slipping, and also enables tracking of how far the belt 24b moves during capping and after slip. In particular, when a bottle and cap assembly initially enters the region of the belts 24a and 24b, such that the cap engages with the belts 24a, 24b, belt 24a moves in the direction of bottle/cap travel and at a speed to rotate the cap onto the bottle, while belt 24b remains stationary due to the mounting of the slip clutch 60. Specifically, the slip clutch 60 is disposed on/about the shaft 45 associated with the belt 24b such that rotation of the shaft 45 urges a rotation of the slip clutch body. However, the slip clutch body includes an associated bracket 47 that interacts with the torque sensor/strain gauge 62a to prevent rotation of the clutch body, which prevents any significant rotation of the shaft 45 and thus prevents movement of the belt 24b. Only when the force of the cap against the belt 24b is sufficient to urge rotation of the shaft 45 with a torque that exceeds the torque at which the slip clutch slips, will the shaft 45 actually begin to rotate (slipping relative to the slip clutch body) and such rotation will be detected by the displacement detection system 64. In embodiments, when shaft 45 does begin to rotate, the gear arrangement 49 is configured such that rotation of gear 49a by shaft 45 urges a rotation of gear 49b in a direction that will slow down the speed of a shaft 51 that drives the belt 24a, such that the sum of the speeds of the two belts 24a and 24b remains substantially the same at all times.

At the upstream end of the capping station 16, a cap sensing system 70 is provided (e.g., formed by a sensor 70a and a mirror 70b). The cap sensing system detects the entering cap, and then the cap position is tracked by the controller 100 via an encoder so that the position of each cap is known. In particular, a container delivered by an infeed conveyor is grabbed by the transport belts 26a, 26b, which are driven by motor 27. The container hooks a cap sitting in a cap distributor and the cap then follows the container through the machine. The cap passed in front of the cap sensing system 70 and the position of the cap and the container on which it is engaged is then defined and known. The transport belts 26a, 26b are linked by a drive shaft 29 to an encoder 31 that is used by the controller to track movement of the belts, 26a. 26b, and thus movement of the container and cap through the process. This enables different inspections on the cap, such as inspecting the final or finish torque when the cap is known to be present in between the belts of the downstream cap rotating section 22.

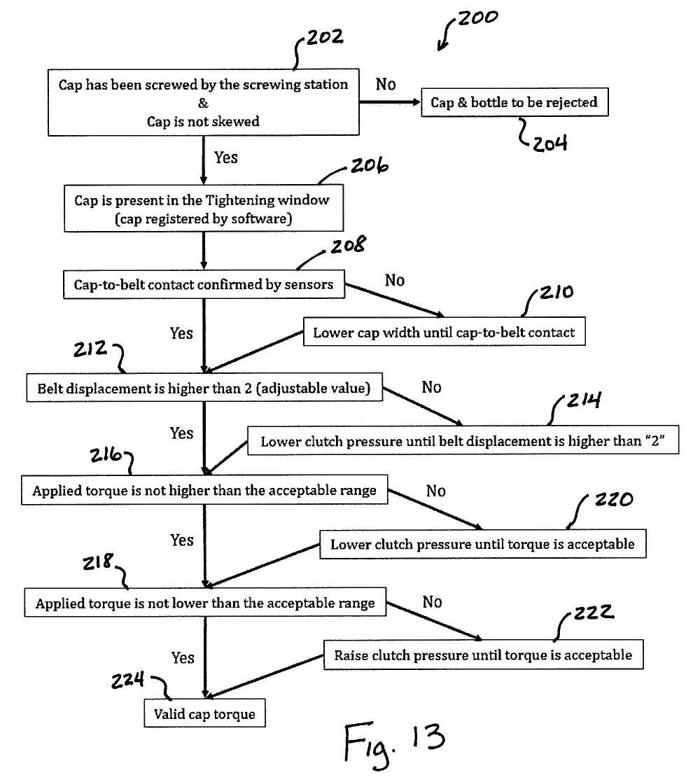

An exemplary sequence of cap application and torque adjustment is now described with respect to flow chart 200 of FIG. 13. Per step 202, a determination of whether the cap has been initially screwed on by the upstream cap rotating section 18 without being skewed (e.g., by passing between the emitter and detector of a precision laser sensor system 33). If the determination at step 202 is no, the controller identifies the cap and associated bottle for rejection per 204. The actual rejection in such case can occur at a downstream location where the bottle is somehow automatically moved out of the flow path of acceptable containers (e.g., by a blow mechanism or some physically moved component (e.g., a pusher or a gate)). If the determination at step 202 is yes, the presence of the cap in the cap rotating section 22 is identified per 206 (e.g., by the continuous tracking of cap and container from the location of the cap sensing system 70).

At step 208, the controller determines whether the belts 24a, 24b are making good contact with the cap (e.g., per the use of the above-described sensors 52a, 52b, 54a, 54b). If the determination at step 208 is no, the cap and bottle is identified by the controller for downstream rejection and the controller effects operation of the motor 36 to rotate the shaft until contact between the belts 24a, 24b and downstream caps is detected, per step 210.

If the determination step 208 is yes, then the controller determines whether the displacement of the belt 24b during final cap tightening/torquing is sufficient (e.g., per the above-described displacement detection system 64), per step 212. If the determination at step 212 is no, then the controller operates the clutch pressure control assembly 80 to lower the clutch pressure until the belt displacement (belt 24b) of downstream caps is acceptable, per step 214, and may also identify the cap and bottle for downstream rejection. By assuring that the belt 24b moves at least a threshold amount after slip occurs, the system assures that the finish torque is applied to the caps for a sufficient amount of time to achieve desired cap tightening.

If the determination at step 212 is yes, then the controller determines whether the final or finish torque of the applied cap satisfies an established torque criteria (e.g., here being within an acceptable torque range) by use of the torque sensing arrangement 62, per steps 216 and 218. If the determination at step 216 is no, meaning the finish torque is higher than the acceptable torque range, then, per step 220, the controller operates the clutch pressure control assembly 80 to lower the clutch pressure until the determination at 216 is yes for downstream caps. If the determination at step 218 is no, meaning the finish torque is below the acceptable torque range, then, per step 222, the controller operates the clutch pressure control assembly 80 to raise the clutch pressure until the determination at step 218 is yes for downstream caps. If the determination at step 218 is yes, then the controller identifies the container and cap as meeting the torque specification, per step 224.

In embodiments, the actual finish torque evaluated in steps 216 and 218 may be a running or moving average of some specified number of caps (e.g., at least 10 caps, such as at least 20 caps or at least 30 caps or forty or more caps, such as 50 caps, or between 20 and 100 caps). This prevents the machine from attempting to over-adjust or cycle adjustments excessively. The data from the capping operations (e.g., the running average and accept/reject data) can be stored in controller memory to facilitate necessary operations.

In embodiments, the control system includes a user interface 120 that provides the ability for the operator to select or adjust the acceptable torque range that will be used for a given capping operation. For example, the operator may enter or adjust the range on a touch-screen, or the controller may simply identify a specific cap or product being capped, which cap or product may have an associated acceptable torque range associated therewith in controller memory.

It is to be clearly understood that the above description is intended by way of illustration and example only, is not intended to be taken by way of limitation, and that other changes and modifications are possible. For example, automated torque adjustment could be implemented in embodiments of capping machines in which only one pair of laterally opposed cap screwing belts are provided. Other variations are possible.

1. A method of capping containers in a capping machine that includes a container path along which containers move and a capping station at which threaded caps are rotated onto threaded finishes of the containers, wherein the capping station includes a pair of laterally opposed cap screwing belts that are operated and configured to screw threaded caps during container movement, the method comprising:
automatically determining a torque applying characteristic during application of the threaded caps;
automatically comparing the torque applying characteristic to an established torque criteria; and
if a result of the comparison indicates that the torque applying characteristic is not consistent with the established torque criteria, automatically adjusting at least one component of the capping machine to bring the torque applying characteristic back into consistency with the established torque criteria.

2. The method of claim 1, wherein the torque applying characteristic is a running average of detected finish torque for a plurality of threaded capping operations.

3. The method of claim 2, wherein the established torque criteria comprises a set acceptable finish torque range.

4. The method of claim 3, wherein the step of automatically adjusting at least one component involves automatically adjusting a slipping torque of a slip clutch associated with one of the cap screwing belts, wherein the slip clutch is mounted to prevent substantial movement of one of the cap screwing belts until the slip clutch slips.

5. The method of claim 4, wherein the step of automatically determining the torque applying characteristic involves the use of an output of a torque sensor when the slip clutch is slipping during cap tightening.

6. The method of claim 1, further comprising:
automatically adjusting a lateral position of at least one of the cap screwing belts relative to the container path based upon a sensed condition.

7. The method of claim 6, wherein the sensed condition is whether caps cause a specified lateral shift in at least one of the cap screwing belts based upon an output from a sensor associated with a biasing system that urges the at least one of the cap screwing belts toward the container path.

8. The method of claim 7, wherein the sensor moves with a component of the biasing system.

9. The method of claim 1, wherein the capping station includes an initial cap rotating section and a downstream cap rotating section, wherein the pair of laterally opposed cap screwing belts that are located in the downstream cap rotating section, and the initial cap rotating section includes a further pair of laterally opposed cap screwing belts that are operated and configured for initial screwing of caps onto containers.

10. A method of adjusting a capping machine that includes a container path along which a container moves and a capping station having a pair of laterally opposed cap screwing belts that are operated and configured to screw a threaded cap onto the container during container movement, the capping machine also including a controller, the method comprising at least one of:
the controller detecting whether the threaded cap causes a specified lateral shift in at least one of the cap screwing belts and, if not, automatically decreasing a lateral spacing between the cap screwing belts;
and/or
the controller detecting whether a specified one of the cap screwing belts moves at least a specified distance during application of the threaded cap onto the container and, if not, automatically lowering a pressure applied to a slip-clutch associated with the specified one of the cap screwing belts.

11. The method of claim 10, wherein:
if the controller detects that the threaded cap does not cause the specified lateral shift, the controller identifies the container and threaded cap for rejection;
and
if the controller detects that the specified one of the cap screwing belts does not move at least the specified distance, the controller identifies the container and threaded cap for rejection.

12. The method of claim 10, wherein the controller detects whether the threaded cap causes the specified lateral shift in at least one of the cap screwing belts based upon an output from a sensor associated with a biasing system that urges at least one of the cap screwing belts toward the container path.

13. The method of claim 12, wherein the sensor moves with a component of the biasing system.

14. The method of claim 10, wherein the controller detects whether the specified one of the cap screwing belts moves at least the specified distance during application of the threaded cap onto the container based upon an output of a sensor arrangement at a side of the slip clutch that is opposite the specified one of the cap screwing belts.

15. A capping machine, comprising:
a container path along which containers move; and
a capping station at which threaded caps are rotated onto threaded finishes of the containers, wherein the capping station includes a pair of laterally opposed cap screwing belts that are operated and configured to screw threaded caps during container movement;
a control system configured to:
automatically determine a torque applying characteristic during application of the threaded caps;
automatically compare the torque applying characteristic to an established torque criteria; and
if a result of the comparison indicates that the torque applying characteristic is not consistent with the established torque criteria, automatically adjust at least one component of the capping machine to bring the torque applying characteristic back into consistency with the established torque criteria.

16. The capping machine of claim 15, wherein the torque applying characteristic is a running average of detected finish torque for a plurality of threaded capping operations wherein the established torque criteria comprises a set acceptable finish torque range.

17. The capping machine of claim 16, wherein the control system is configured such that the automatic adjusting of at least one component involves automatically varying a slipping torque of a slip clutch associated with one of the cap screwing belts, wherein the slip clutch is mounted to prevent substantial movement of one of the cap screwing belts until the slip clutch slips.

18. The capping machine of claim 17, further comprising a pressure control assembly that is operated to vary the slipping torque.

19. The capping machine of claim 17, wherein determining the torque applying characteristic involves the use of an output of a torque sensor when the slip clutch is slipping during cap tightening.

20. The capping machine of claim 15, wherein the control system is further configured to automatically adjust a lateral position of at least one of the cap screwing belts relative to the container path based upon sensing of whether the at least one of the cap screwing belts is shifted laterally by a cap.
